(19) United States
(12) Patent Application Publication
(10) Pub. No.: US 2022/0178051 A1
(43) Pub. Date: Jun. 9, 2022

(54) RECYCLED POLYESTER BINDER FIBER

(71) Applicant: PRIMALOFT, INC., Latham, NY (US)

(72) Inventor: Jon-Alan MINEHARDT, Clifton Park, NY (US)

(73) Assignee: PRIMALOFT, INC., Latham, NY (US)

(21) Appl. No.: 17/602,173

(22) PCT Filed: Jul. 8, 2020
(86) PCT No.: PCT/US2020/041183

§ 371 Date: Oct. 7, 2021

Related U.S. Application Data
(60) Provisional application No. 62/874,237, filed on Jul. 15, 2019.

(51) Int. Cl. D01F 8/14; C08L 67/02; D01D 5/08

(52) U.S. Cl. CPC D01F 8/14; C08L 67/02; D01D 5/08; C08L 2205/06; C08L 2205/025; C08L 2207/20; C08L 2203/12

(57) ABSTRACT

The invention provides polyester binder fibers comprising: a component comprising polyester and a melting point-reducing additive, wherein at least 80 wt % of the polyester is recycled polyester.

### CROSS REFERENCE TO RELATED APPLICATIONS

This application claims the benefit of U.S. provisional application No. 62/874,237, filed on Jul. 15, 2019, the entire contents of which are hereby incorporated by reference herein.

### FIELD OF THE INVENTION

The present disclosure generally relates to polyester fiber, and, in particular, recycled polyester fiber, and methods of making the same.

### BACKGROUND OF THE INVENTION

Thermally bonded polyester batting insulations employ low melt binder fibers. Thermally bonded insulations offer desirable properties, such as favorable stability, and are useful in various applications, including in articles intended for rugged or high aerobic activities. Binder fibers used are typically single or multi-component (e.g., bi-component) fibers, such as polyester/co-polyester fibers. Commercially available binder fibers are made using virgin polymer (e.g., virgin polyester), which are not environmentally friendly. However, attempts at making a recycled polyester binder fiber have been unsuccessful.

Thus, a need remains for binder fiber that is more eco-friendly, but that does not unduly sacrifice fiber quality and properties.

While certain aspects of conventional technologies have been discussed to facilitate disclosure of the disclosure, Applicant in no way disclaims these technical aspects, and it is contemplated that the claimed disclosure may encompass one or more of the conventional technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, the present invention satisfies the need for a recycled polyester binder fiber that can be utilized in various industries, including in the manufacture of articles such as insulation. The present disclosure may address one or more of the problems and deficiencies of the art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

Certain embodiments of the presently-disclosed fiber, articles comprising the fiber, and methods for making the fiber have several features, no single one of which is solely responsible for their desirable attributes. Without limiting the scope of the fiber, articles, and methods as defined by the claims that follow, their more prominent features will now be discussed briefly. After considering this discussion, and particularly after reading the section of this specification entitled “Detailed Description of the Invention,” one will understand how the features of the various embodiments disclosed herein provide a number of advantages over the current state of the art. For example, embodiments of the inventive fiber offer eco-friendly low-melting polyester binder fibers that can be readily incorporated into articles such as batting as a green alternative to virgin polyester binder fibers.

In a first aspect, the invention provides a fiber comprising: a component comprising polyester and a melting point-reducing additive, wherein at least 80 wt % of the polyester is recycled polyester, and wherein the component has a melting point of 70 to 180° C.

In a second aspect, the invention provides a multicomponent fiber comprising: a first component comprising polyester, wherein at least 80 wt % of the polyester is recycled polyester, the first component having a melting point MP1; and a second component comprising polyester, wherein at least 80 wt % of the polyester is recycled polyester, the second component having a melting point MP2, wherein MP2 is less than MP1.

In a third aspect, the invention provides an article comprising the fiber according to the first or second aspects of the invention. In some embodiments, the article is insulation (e.g., batting, such as thermally bonded batting). In some embodiments, the article is a product comprising batting, e.g., a sleeping bag, outerwear, active wear, a home good, etc.

In a fourth aspect, the invention provides a method of making the fiber according to the first or second aspect of the invention.

These and other features and advantages of this invention will become apparent from the following detailed description of the various aspects of the invention taken in conjunction with the appended claims and the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features, aspects, and advantages of the disclosure will be readily understood from the following detailed description taken in conjunction with the accompanying drawings, which are not necessarily drawn to scale, wherein:

FIG. 1 depicts a portion of an embodiment of inventive low-melt polyester binder fiber.

FIGS. 2A and 2B depict embodiments of insulation web after heat treatment, wherein binder fibers have melted, thus bonding other fibers of the web.

FIG. 3 depicts various non-limiting conformations of multicomponent embodiments of the inventive binder fiber.

### DETAILED DESCRIPTION OF THE INVENTION

Aspects of the present invention and certain features, advantages, and details thereof, are explained more fully below, at times with reference to the non-limiting embodiments illustrated in the accompanying drawings. Descriptions of well-known materials, fabrication tools, processing techniques, etc., are omitted so as to not unnecessarily obscure the disclosure in detail. It should be understood, however, that the detailed description and the specific example(s), while indicating embodiments of the invention, are given by way of illustration only, and are not by way of limitation. Various substitutions, modifications, additions and/or arrangements within the spirit and/or scope of the underlying inventive concepts will be apparent to those skilled in the art from this disclosure.

The present invention provides recycled polyester binder fiber embodiments that represent an eco-friendly alternative to commercially available binder fibers. Embodiments of the invention include a recycled (e.g., post-consumer recycled (PCR)) polyester low melt binder fiber that is beneficial, e.g., in forming robust, durable, recycled batting.

In one aspect, the invention provides a fiber comprising: a component comprising polyester and a melting point-reducing additive, wherein at least 80 wt % of the polyester is recycled polyester, and wherein the component has a melting point of 70 to 180° C.

As used herein, “recycled polyester” includes both post-consumer recycled (PCR) polyester (e.g., recycled bottles) and post-industrial (also known as post-production) recycled polyester (e.g., recycled polyester bottle chip/flake and polyester textile waste). Recycled polyester is different from virgin polyester, which is newly-manufactured plastic that has not yet been made into a product.

In some embodiments, the recycled polyester used in the inventive fiber is polyester that has gone through a melt-recycling process and/or a chemical recycling process (e.g., where polyester is chemically broken down, and is then repolymerized to polyester).

In some embodiments, recycled polyester is the recycled polyester resin as described in U.S. Patent Publication No. 20030096882.

Some differences between virgin polyester and certain recycled polyester embodiments are described in Polyester Fiber Production Using Virgin and Recycled PET, Fibers and Polymers⋅March 2014. In some embodiments, the recycled polyester used in the present invention includes embodiments of recycled polyester discussed in the reference.

In some embodiments, recycled polyester has one or more mechanical properties different from virgin polyester. Mechanical properties include, but are not limited to, tensile strength, breaking stress, break elongation, and Young's modulus.

In some non-limiting embodiments, recycled polyester has a higher tensile strength than virgin polyester. Recycled polyester can have an array of tensile strengths. In some embodiments, recycled polyester has a tensile strength of greater than 130 kg/cm², greater than 140 kg/cm², greater than 150 kg/cm², greater than 160 kg/cm², greater than 170 kg/cm², greater than 180 kg/cm², greater than 190 kg/cm², or greater than 200 kg/cm². In some embodiments, recycled polyester has a tensile strength of 130 kg/cm² to 250 kg/cm² (e.g., 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, or 250 kg/cm²), including any and all ranges and subranges therein (e.g., 140 to 230 kg/cm², 200 to 230 kg/cm², etc.).

In some non-limiting embodiments, recycled polyester has a lower breaking stress than virgin polyester. Recycled polyester can have an array of breaking stress values. In some embodiments, recycled polyester has a breaking stress of less than 90 kg/cm², less than 80 kg/cm², less than 70 kg/cm², less than 60 kg/cm², or less than 50 kg/cm². In some embodiments, recycled polyester has a breaking stress of 30 kg/cm² to 90 kg/cm² (e.g., 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 kg/cm²), including any and all ranges and subranges therein (e.g., 35 to 83 kg/cm², 35 to 75 kg/cm², 38 to 50 kg/cm², etc.).

In some non-limiting embodiments, recycled polyester has a lower break elongation than virgin polyester. Recycled polyester can have an array of break elongations. In some embodiments, recycled polyester has a break elongation of less than 8%, or less than 7%, or less than 6%. In some embodiments, recycled polyester has a break elongation of 4 to 8% (e.g., 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or 8.0%), including any and all ranges and subranges therein (e.g., 4.5 to 7.5%, 4.5 to 6%, etc.).

In some non-limiting embodiments, recycled polyester has a Young's modulus greater than virgin polyester. Recycled polyester can have an array of Young's modulus values. In some embodiments, recycled polyester has a Young's modulus of greater than 5000 kg/cm², greater than 6000 kg/cm², greater than 7000 kg/cm², greater than 8000 kg/cm², greater than 9000 kg/cm², or greater than 10000 kg/cm². In some embodiments, recycled polyester has a Young's modulus of 5000 kg/cm² to 12000 kg/cm² (e.g., 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, 10000, 10100, 10200, 10300, 10400, 10500, 10600, 10700, 10800, 10900, 11000, 11500, or 12000 kg/cm²), including any and all ranges and subranges therein (e.g., 5500 to 11000 kg/cm², 6000 to 11000 kg/cm², 7000 to 11000 kg/cm², etc.),

In some embodiments, the recycled polyester complies with the recommendations of the Food and Drug Administration (FDA) for use of recycled plastic materials in food-contact articles, as set forth in the “Guidance for Industry: Use of Recycled Plastics in Food Packaging (Chemistry Considerations)” (August 2006). In other embodiments, the recycled polyester used in the inventive fiber does not comply with the recommendations of the FDA for use of recycled plastic materials in food-contact articles, as set forth in the “Guidance for Industry: Use of Recycled Plastics in Food Packaging (Chemistry Considerations)” (August 2006). This could be, e.g., due to contaminant levels in the polyester that would be acceptable in other industries.

In some embodiments, the recycled polyester comprises one or more contaminants. In some embodiments, one or more contaminants are present from the recycling process. In some embodiments, the one or more contaminants comprise an oxygen scavenger, reheat enhancer, other additive used in an original product (e.g., container), pieces (e.g., microscopic) of foreign material (e.g., other polymer/plastic, glass, sand, and/or metal). In various embodiments, such contaminants are bound in the recycled polyethylene and do not pose a hazard.

In some embodiments, the recycled polyester comprises less than or equal to 5 weight percent (wt %) contaminant(s), or less than or equal to 4, 3, 2, 1, or 0.5 wt % contaminant(s). In some embodiments, the recycled polyester comprises 0 to 5 wt % contaminants (e.g., 0, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt %), including any and all ranges and subranges therein.

In some embodiments, the polyester fiber comprises one or more of poly(ethylene terephthalate), poly(hexahydro-p-xylylene terephthalate), poly(butylene terephthalate), poly-1,4-cyclohexelyne dimethylene (PCDT) and terephthalate copolyesters in which at least 85 mole percent of the ester units are ethylene terephthalate or hexahydro-p-xylylene terephthalate units. In particular embodiments, the fiber comprises polyethylene terephthalate (PET).

In some embodiments, the recycled polyester has properties in common with that described in WO 2014146582. In some embodiments, the recycled polyester is different from that described in WO 2014146582 (e.g., has properties different from those described in the reference).

The melting point-reducing additive is an additive that reduces the melting point of polyester (e.g., PET). The melting point-reducing additive can be any art-known additive that reduces the melting point of polyester. In some embodiments, the melting point-reducing additive is a glycol (e.g., an alkyl glycol, such as ethylene glycol, propylene glycol, neopentyl glycol, hexylene glycol, butylene glycol, polyethylene glycol etc.). In some embodiments, the recycled polyester is modified via glycol modification. In some embodiments, the melting point-reducing additive is a constituent that modifies polyester by exchanging a percentage of terephthalic acid with isophthalic acid. In some embodiments, such methods create a co-polyester (e.g., PET) with a lower melting point by slightly modifying the PET polyester chain. In some embodiments, the melting point-reducing additive comprises a plasticizer which, when added during the manufacturing process, modifies the polymer chain to adjust the polymer attributes to be a lower melting point. In some embodiments, the melting point-reducing additive comprises a multifunctional compound, for example a compound having two or more terminal functional groups independently selected from hydroxyl (—OH), carboxyl (—COOH), and carboxymethyl (—COOMe), wherein the compound may be further optionally substituted. In some embodiments, the melting point-reducing additive comprises dimethyl isophthalate or a diol (e.g., a fatty acid diol, dimer diol, hydrocarbon diol, alkyl diol, e.g., 2-methyl-1,3-propanediol, etc.).

In some embodiments, the melting point-reducing additive and the polyester (e.g., recycled polyester) are present in a mixture (e.g., a homogenous mixture), but have not been reacted with one another so as to modify the polyester chain.

In some embodiments of the inventive fiber, at least 80 wt % of the polyester is recycled polyester, e.g., at least 80, 81, 82, 83, 84, 85, 86, 87, 88, 89, 90, 91, 92, 93, 94, 95, 96, 97, 98, 99, 99.5, 99.6, 99.7, 99.8, or 99.9 wt % recycled polyester. In some embodiments, 100 wt % of the polyester in the fiber is recycled polyester.

The inventive fiber comprises low-melt polyester fiber, having a melting point of 70 to 180° C. (e.g., 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, or 180° C.), including any and all ranges and subranges therein.

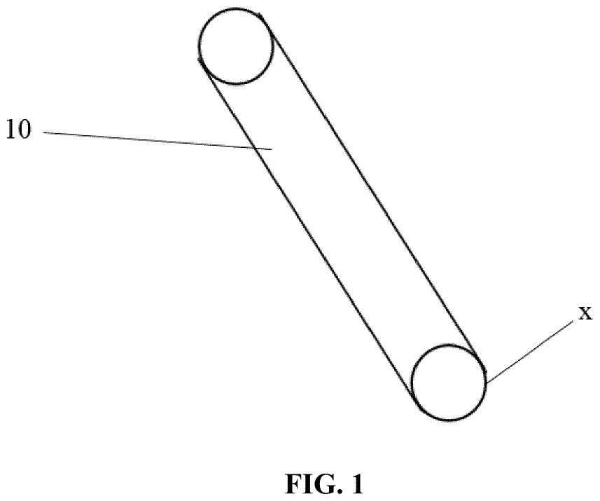

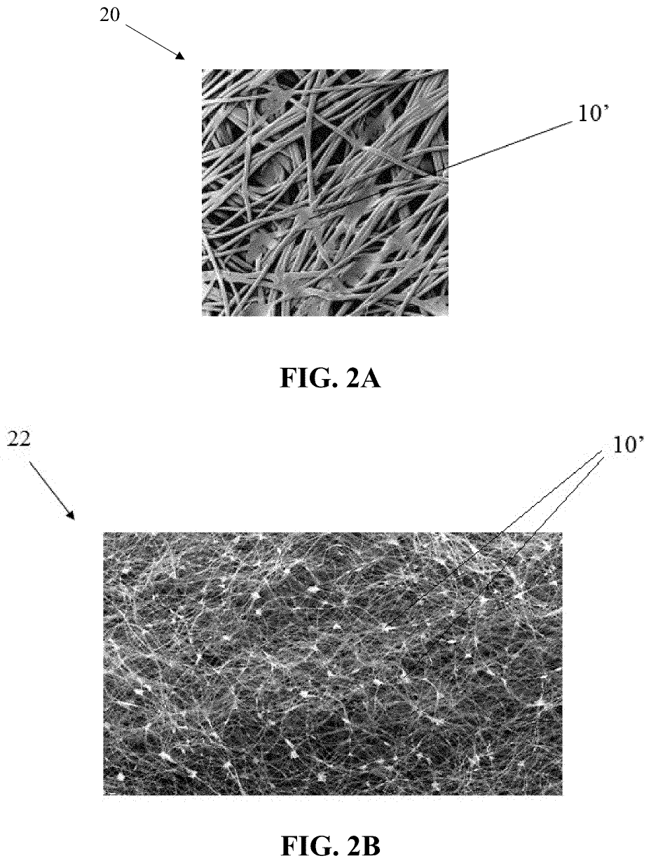

FIG. 1 depicts a portion of an embodiment of inventive polyester binder fiber, 10. In FIG. 1, X is a cross-section of Fiber 10. Fiber 10 is made of a single component (i.e., fiber 10 is a monocomponent fiber), which comprises 100% PCR PET. When used in batting insulation, binder fibers work by being intimately integrated into a web of the insulation. Once the insulation or web is at a desired thickness (established by, e.g., cross-lapping, vertical lapping, or airlaying web(s)), the insulation/web is typically heated, for example, by being passed through an oven. During heating, the binder fiber, or at least a portion thereof, melts and adheres to other fibers in the insulation. FIGS. 2A and 2B depict insulation webs 20 and 22, respectively, wherein binder fibers 10 have melted into binder fibers 10′, thus bonding other fibers of webs 20 and 22.

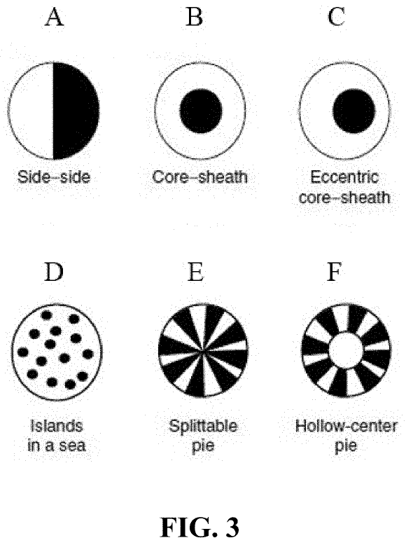

In some embodiments, the inventive fiber is a monocomponent fiber, meaning that the fiber contains a single material having the same properties. In other embodiments, the fiber is a multicomponent fiber having two or more (e.g., 2, 3, 4, etc.) different components (e.g., a bicomponent, tricomponent, etc.) fiber. FIG. 3 depicts various non-limiting conformations of multicomponent embodiments of the inventive binder fiber.

Denier is a unit of measure defined as the weight in grams of 9000 meters of a fiber or yarn. It is a common way to specify the weight (or size) of the fiber or yarn. For example, polyester fibers that are 1.0 denier typically have a diameter of approximately 10 micrometers. Micro-denier fibers are those having a denier of 1.0 or less, while macro-denier fibers have a denier greater than 1.0.

In some embodiments, the inventive binder fiber has a denier of 1.0 to 6.0 denier (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.0 denier), including any and all ranges and subranges therein (e.g., 1.0 to 3.0 denier, 1.5 to 2.5 denier, etc.).

In some embodiments, the inventive fiber is a staple fiber (i.e., a fiber having a standardized length). For example, in some embodiments, the inventive fiber is a staple fiber having a length of 5 to 120 mm (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120 mm), including any and all ranges and subranges therein (e.g., 12 to 90 mm, 40 to 60 mm, etc.). In some embodiments, the invention provides a plurality of polyester binder staple fibers.

In a second aspect, the invention provides a multicomponent fiber comprising: a first component comprising polyester, wherein at least 80 wt % of the polyester is recycled polyester, the first component having a melting point MP1; and a second component comprising polyester, wherein at least 80 wt % of the polyester is recycled polyester, the second component having a melting point MP2, wherein MP2 is less than MP1.

Comparatively speaking, the component having melting point MP2 can be considered a low melting point polyester.

Fibers according to the second aspect of the invention are encompassed by, and share properties and embodiments in common with the first aspect of the invention. Likewise, in some embodiments, the component of the first aspect of the invention shares properties and features with the second component of the second aspect of the invention.

In some embodiments, the second component comprises polyester and a melting point-reducing additive, as described above.

In some embodiments, with respect to the second component, the melting point-reducing additive and the polyester are present in a mixture, but have not been reacted with one another so as to modify the polyester chain.

In some embodiments, the second component comprises modified polyester having a percentage of terephthalic acid replaced with isophthalic acid.

In some embodiments, the first and/or second component comprises at least 85 wt % polyester (e.g., 85, 86, 87, 88, 89, 90, 91, 92, 93, 94, 95, 96, 97, 98, 99, or 100 wt % polyester).

In some embodiments, the polyester in the first and/or second component is at least 70 wt % recycled polyester. For example, in some embodiments, the polyester in the first and/or second component is 70 to 100 wt % recycled polyester (e.g., 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt % recycled polyester) (e.g., PCR, post-industrial recycled polyester, or a combination thereof), including and all ranges and subranges therein.

In some embodiments, MP1 is 220 to 270° C. (e.g., 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, or 270° C.), including any and all ranges and subranges therein.

In some embodiments, MP2 is 70 to 180° C. (e.g., 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, or 180° C.), including any and all ranges and subranges therein.

In some embodiments, the multicomponent fiber has a configuration selected from: core-sheath, wherein the core comprises the first component and the sheath comprises the second component; islands in a sea, wherein the islands comprise the first component and the sea comprises the second component; side-by-side, wherein the first component is adjacent to the second component; splittable pie, having segments comprising the first component, and other segments comprising the second component; or hollow-center pie, having segments comprising the first component, and other segments comprising the second component, the fiber having a hollow center.

In some embodiments, the multicomponent fiber comprises 20 to 90 wt % of the first component (e.g., 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %), including any and all ranges and subranges therein.

In some embodiments, the multicomponent fiber comprises 10 to 80 wt % of the second component (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %), including any and all ranges and subranges therein.

The inventive binder fiber may be crimped or uncrimped. Various crimps, including spiral (i.e., helical) and standard crimp, are known in the art. The inventive fiber may have any desired crimp.

In a third aspect, the invention provides an article comprising the fiber according to the first or second aspects of the invention. In some embodiments, the article is insulation (e.g., batting, such as thermally bonded batting). In some embodiments, the article is a product comprising batting, e.g., a sleeping bag, outerwear, active wear, a home good, etc.

The inventive articles, in some embodiments, have been heat treated so as melt all or a portion of the binder fibers, thereby forming a bonded web-type batting. Persons having ordinary skill in the art will understand that, in such embodiments, although “binder fibers” are recited as being comprised within the batting, said fibers may be wholly or partially melted fibers, as opposed to binder fibers in their original, pre-heat treatment form.

In some embodiments, batting (or other articles) comprising the inventive recycled polyester binder fiber additionally comprise natural and/or other synthetic fibers.

Many synthetic fibers are known in the art, and any desired synthetic fibers may be used in the invention. Indeed, different fibers have different properties, and lend themselves toward advantageous uses in different applications. This information is well within the purview of persons having ordinary skill in the art. While a wide array of synthetic fibers may be used in the invention, in some embodiments, the additional synthetic fibers are selected from the group consisting of polyamide, polyester, polypropylene, polylactic acid (PLA), poly(butyl acrylate) (PBA), acrylic, acrylate, acetate, polyolefin, nylon, rayon, lyocell, aramid, spandex, viscose, and modal fibers, and combinations thereof. In some embodiments, natural fibers are included, e.g., one or more members selected from wool, cotton, tencel, kapok (cotton-like fluff obtained from seeds of a Kapok tree, which may optionally be further processed before use), flax, animal hair, silk, and down (e.g., duck or goose down).

In some embodiments, the invention provides batting comprising the inventive polyester binder fiber. In some embodiments, the batting has a thickness of 1 mm to 160 mm (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104 105, 106, 107, 108, 109, 110, 111, 112, 113, 114, 115, 116, 117, 118, 119, 120, 121, 122 123, 124, 125, 126, 127, 128, 129, 130, 131, 132, 133, 134, 135, 136, 137, 138, 139, 140 141, 142, 143, 144, 145, 146, 147, 148, 149, 150, 151, 152, 153, 154, 155, 156, 157, 158, 159, or 160 mm), including any and all ranges and subranges therein. In some embodiments, the thickness is less than or equal to 40 mm, e.g., 2 to 40 mm. In some non-limiting embodiments, the batting has a density of 1 to 10 kg/m³ (e.g., 1, 2, 3, 4, 5, 6, 7, 8, 9, or 10 kg/m³), including any and all ranges and subranges therein.

In a fourth aspect, the invention provides a method of making the fiber according to the first or second aspect of the invention.

In some embodiments, e.g., with respect to some embodiments of the first aspect of the invention, the inventive method comprises extruding component material for the component, and, where one or more additional components are present, extruding component material for the one or more additional components, feeding the component material and, where present, the one or more additional component materials into a polymer distribution system, and extruding the component material and, where present, the one or more additional component materials, from a spinneret.

In some embodiments, e.g., with respect to some embodiments of the second aspect of the invention, the inventive method comprises separately extruding first component material and second component material, feeding the first component material and second component material into a polymer distribution system, and extruding the first component material and second component material from a spinneret.

In some embodiments, the inventive fiber is made by reactive extrusion.

Reactive extrusion is a processing technique that involves mixing desired components (e.g., monomers, polymers, coupling agents (which can also be referred to as a chain extender, and is used to link separated polymer chains by reacting with end groups in the polymer chains), additives, etc.) and processing them in extruders to carry out various types of reactions (e.g., polymerization). The technique can be utilized to modify the nature and properties of polymeric material (e.g., polymer(s)). In some embodiments, reactive extrusion is a continuous process. Embodiments of reactive extrusion processes are described, for example, in Alzahrani, M., Thesis: “Modification of Recycled Poly(ethylene terephthalate) for FDM 3D-Printing Applications”, Waterloo, Ontario, Canada, 2017, Awaj a, F. et al., Recycling of PET, European Polymer Journal (2005), and Mohsin, M. et al., “Reactive Extrusion of Polyethylene Terephthalate Waste and Investigation of Its Thermal and Mechanical Properties after Treatment”, Hindawi, International Journal of Chemical Engineering (2017).

In some embodiments, the invention is as described in the following clauses:

### Clauses

1. A multicomponent fiber comprising: a first component comprising polyester, wherein at least 80 wt % of the polyester is recycled polyester, the first component having a melting point MP1; and a second component comprising polyester, wherein at least 80 wt % of the polyester is recycled polyester, the second component having a melting point MP2, wherein MP2 is less than or equal to MP1.
2. The multicomponent fiber according to clause 1, wherein the second component comprises polyester and a melting point-reducing additive.
3. The multicomponent fiber according to clause 2, wherein the melting point-reducing additive is a glycol.
4. The multicomponent fiber according to clause 2 or clause 3, wherein, with respect to the second component, the melting point-reducing additive and the polyester are present in a mixture, but have not been reacted with one another so as to modify the polyester chain.
5. The multicomponent fiber according to clause 1, wherein the second component comprises modified polyester having a percentage of terephthalic acid replaced with isophthalic acid.
6. The multicomponent fiber according to any one of the preceding clauses, wherein the second component comprises a plasticizer.
7. The multicomponent fiber according to any one of the preceding clauses, wherein the first component comprises at least 85 wt % polyester.
8. The multicomponent fiber according to clause 7, wherein the polyester in the first component is 100% recycled polyester.
9. The multicomponent fiber according to clause 8, wherein the polyester in the first component is 100% post-consumer-recycled polyester.
10. The multicomponent fiber according to any one of the preceding clauses, wherein the second component comprises at least 70 wt % polyester.
11. The multicomponent fiber according to clause 10, wherein the polyester in the second component is 100% recycled polyester.
12. The multicomponent fiber according to clause 11, wherein the polyester in the second component is 100% post-consumer-recycled polyester.
13. The multicomponent fiber according to any one of the preceding clauses, wherein MP1 is 220 to 270° C.
14. The multicomponent fiber according to any one of the preceding clauses, wherein MP2 is 70 to 180° C.
15. The multicomponent fiber according to any one of the preceding clauses, having a configuration selected from: core-sheath, wherein the core comprises the first component and the sheath comprises the second component; islands in a sea, wherein the islands comprise the first component and the sea comprises the second component; side-by-side, wherein the first component is adjacent to the second component; splittable pie, having segments comprising the first component, and other segments comprising the second component; or hollow-center pie, having segments comprising the first component, and other segments comprising the second component, the fiber having a hollow center.
16. The multicomponent fiber according to any one of the preceding clauses, wherein the fiber has a denier of 1.0 to 6.0 denier.
17. The multicomponent fiber according to any one of the preceding clauses, wherein the fiber has a length of 12 mm to 90 mm.
18. The multicomponent fiber according to any one of the preceding clauses, wherein the fiber comprises 20 to 90 wt % of the first component.
19. The multicomponent fiber according to any one of the preceding clauses, wherein the fiber comprises 10 to 80 wt % of the second component.
20. A method of making the multicomponent fiber according to any one of the preceding clauses, the method comprising separately extruding first component material and second component material, feeding the first component material and second component material into a polymer distribution system, and extruding the first component material and second component material from a spinneret.
21. A fiber comprising: a component comprising polyester and a melting point-reducing additive, wherein at least 80 wt % of the polyester is recycled polyester, and wherein the component has a melting point of 70 to 180° C.
22. The fiber according to clause 21, wherein the fiber is a single component fiber.
23. The fiber according to clause 21 or clause 22, wherein the melting point-reducing additive is a glycol.
24. The fiber according to any one of clauses 21 to 23, wherein the melting point-reducing additive and the polyester are present in a mixture, but have not been reacted with one another so as to modify the polyester chain.
25. The fiber according to clause 21, wherein the component comprises modified polyester having a percentage of terephthalic acid replaced with isophthalic acid.
26. The fiber according to any one of clauses 21 to 25, wherein the component comprises a plasticizer.
27. The fiber according to any one of clauses 21 to 26, wherein the component comprises at least 85 wt % polyester.
28. The fiber according to clause 27, wherein the polyester in the component is 100% recycled polyester.
29. The fiber according to clause 28, wherein the polyester in the component is 100% post-consumer-recycled polyester.
30. The fiber according to any one of clauses 21 to 29, comprising an additional component, which comprises at least 70 wt % polyester.
31. The fiber according to clause 30, wherein the polyester in the additional component is 100% recycled polyester.
32. The fiber according to clause 31, wherein the polyester in the additional component is 100% post-consumer-recycled polyester.
33. The fiber according to any one of clauses 21 to 32, wherein the melting point of the additional component is 220 to 270° C.
34. The fiber according to any one of clauses 21 or 23 to 33, wherein the fiber is a multicomponent fiber comprising the component and an additional component, the additional component having a higher melting point than the component, wherein the fiber has a configuration selected from: core-sheath, wherein the core comprises the additional component and the sheath comprises the component; islands in a sea, wherein the islands comprise the additional component and the sea comprises the component; side-by-side, wherein the additional component is adjacent to the component; splittable pie, having segments comprising the additional component, and other segments comprising the component; or hollow-center pie, having segments comprising the additional component, and other segments comprising the component, the fiber having a hollow center.
35. The fiber according to any one of clauses 21 to 34, wherein the fiber has a denier of 1.0 to 6.0 denier.
36. The fiber according to any one of clauses 21 to 35, wherein the fiber has a length of 12 mm to 90 mm.
37. A method of making the fiber according to any one of clauses 21 to 36, the method comprising extruding component material for the component, and, where one or more additional components are present, extruding component material for the one or more additional components, feeding the component material and, where present, the one or more additional

component materials into a polymer distribution system, and extruding the component material and, where present, the one or more additional component materials, from a spinneret.
38. Batting comprising a fiber according to any one clauses 1-19 or 21-36.
39. The batting according to clause 38, wherein the batting is thermally bonded batting.
40. An article comprising a fiber according to any one of clauses 1-19 or 21-36, or batting according to clause 38 or clause 39.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed compositions or methods.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1. A multicomponent fiber comprising: a first component comprising polyester, wherein at least 80 wt % of the polyester is recycled polyester, the first component having a melting point MP1; and a second component comprising polyester, wherein at least 80 wt % of the polyester is recycled polyester, the second component having a melting point MP2, wherein MP2 is less than or equal to MP1.

2. The multicomponent fiber according to claim 1, wherein the second component comprises polyester and a melting point-reducing additive.

3. The multicomponent fiber according to claim 2, wherein the melting point-reducing additive is a glycol.

4. The multicomponent fiber according to claim 2, wherein, with respect to the second component, the melting point-reducing additive and the polyester are present in a mixture, but have not been reacted with one another so as to modify the polyester chain.

5. The multicomponent fiber according to claim 1, wherein the second component comprises modified polyester having a percentage of terephthalic acid replaced with isophthalic acid.

6. The multicomponent fiber according claim 5, wherein the second component comprises a plasticizer.

7. The multicomponent fiber according to claim 1, wherein the first component comprises at least 85 wt % polyester.

8. The multicomponent fiber according to claim 7, wherein the polyester in the first component is 100% recycled polyester.

9. The multicomponent fiber according to claim 8, wherein the polyester in the first component is 100% post-consumer-recycled polyester.

10. The multicomponent fiber according to claim 1, wherein the second component comprises at least 70 wt % polyester.

11. The multicomponent fiber according to claim 10, wherein the polyester in the second component is 100% recycled polyester.

12. The multicomponent fiber according to claim 11, wherein the polyester in the second component is 100% post-consumer-recycled polyester.

13. The multicomponent fiber according to claim 1, wherein MP1 is 220 to 270° C.

14. The multicomponent fiber according to claim 13, wherein MP2 is 70 to 180° C.

15. The multicomponent fiber according to claim 1, having a configuration selected from: core-sheath, wherein the core comprises the first component and the sheath comprises the second component; islands in a sea, wherein the islands comprise the first component and the sea comprises the second component; side-by-side, wherein the first component is adjacent to the second component; splittable pie, having segments comprising the first component, and other segments comprising the second component; or hollow-center pie, having segments comprising the first component, and other segments comprising the second component, the fiber having a hollow center.

16. The multicomponent fiber according to claim 1, wherein the fiber has a denier of 1.0 to 6.0 denier.

17. The multicomponent fiber according to claim 1, wherein the fiber has a length of 12 mm to 90 mm.

18. The multicomponent fiber according to claim 1, wherein the fiber comprises 20 to 90 wt % of the first component.

19. The multicomponent fiber according to claim 1, wherein the fiber comprises 10 to 80 wt % of the second component.

20. A method of making the multicomponent fiber according to claim 1, the method comprising separately extruding first component material and second component material, feeding the first component material and second component material into a polymer distribution system, and extruding the first component material and second component material from a spinneret.

21. A fiber comprising: a component comprising polyester and a melting point-reducing additive, wherein at least 80 wt % of the polyester is recycled polyester, and wherein the component has a melting point of 70 to 180° C.

22. The fiber according to claim 21, wherein the fiber is a single component fiber.

23. The fiber according to claim 21, wherein the melting point-reducing additive is a glycol.

24. The fiber according to claim 21, wherein the melting point-reducing additive and the polyester are present in a mixture, but have not been reacted with one another so as to modify the polyester chain.

25. The fiber according to claim 21, wherein the component comprises modified polyester having a percentage of terephthalic acid replaced with isophthalic acid.

26. The fiber according to claim 21, wherein the component comprises a plasticizer.

27. The fiber according to claim 21, wherein the component comprises at least 85 wt % polyester.

28. The fiber according to claim 27, wherein the polyester in the component is 100% recycled polyester.

29. The fiber according to claim 28, wherein the polyester in the component is 100% post-consumer-recycled polyester.

30. The fiber according to claim 21, comprising an additional component, which comprises at least 70 wt % polyester.

31. The fiber according to claim 30, wherein the polyester in the additional component is 100% recycled polyester.

32. The fiber according to claim 31, wherein the polyester in the additional component is 100% post-consumer-recycled polyester.

33. The fiber according to claim 21, wherein the melting point of the additional component is 220 to 270° C.

34. The fiber according to claim 21, wherein the fiber is a multicomponent fiber comprising the component and an additional component, the additional component having a higher melting point than the component, wherein the fiber has a configuration selected from: core-sheath, wherein the core comprises the additional component and the sheath comprises the component; islands in a sea, wherein the islands comprise the additional component and the sea comprises the component; side-by-side, wherein the additional component is adjacent to the component; splittable pie, having segments comprising the additional component, and other segments comprising the component; or hollow-center pie, having segments comprising the additional component, and other segments comprising the component, the fiber having a hollow center.

35. The fiber according to claim 21, wherein the fiber has a denier of 1.0 to 6.0 denier.

36. The fiber according to claim 21, wherein the fiber has a length of 12 mm to 90 mm.

37. A method of making the fiber according to claim 21, the method comprising extruding component material for the component, and, where one or more additional components are present, extruding component material for the one or more additional components, feeding the component material and, where present, the one or more additional component materials into a polymer distribution system, and extruding the component material and, where present, the one or more additional component materials, from a spinneret.

38. Batting comprising a fiber selected from:
a multicomponent fiber comprising: a first component comprising polyester, wherein at least 80 wt % of the polyester is recycled polyester, the first component having a melting point MP1, and a second component comprising polyester, wherein at least 80 wt % of the polyester is recycled polyester, the second component having a melting point MP2, wherein MP2 is less than or equal to MP1, and
fiber comprising: a component comprising polyester and a melting point-reducing additive, wherein at least 80 wt % of the polyester is recycled polyester, and wherein the component has a melting point of 70 to 180° C.

39. The batting according to claim 38, wherein the batting is thermally bonded batting.

40. An article comprising a fiber selected from:
a multicomponent fiber comprising: a first component comprising polyester, wherein at least 80 wt % of the polyester is recycled polyester, the first component having a melting point MP1, and a second component comprising polyester, wherein at least 80 wt % of the polyester is recycled polyester, the second component having a melting point MP2, wherein MP2 is less than or equal to MP1, and
fiber comprising: a component comprising polyester and a melting point-reducing additive, wherein at least 80 wt % of the polyester is recycled polyester, and wherein the component has a melting point of 70 to 180° C.
